(19) United States
(12) Patent Application Publication
(10) Pub. No.: US 2010/0128464 A1
(43) Pub. Date: May 27, 2010

(54) LIGHT DIFFUSION PLATE, METHOD FOR MANUFACTURING THE SAME AND BACKLIGHT ASSEMBLY HAVING THE SAME

(76) Inventors: Byung-Yun Joo, Seoul (KR); Min-Young Song, Seoul (KR); Dong-Kwan Kim, Seoul (KR)

Correspondence Address: Innovation Counsel LLP, 21771 Stevens Creek Blvd, Ste. 200A, Cupertino, CA, 95014, US

(21) Appl. No.: 12/541,077

(22) Filed: Aug. 13, 2009

(30) Foreign Application Priority Data
Nov. 21, 2008 (KR) 2008-116273

(51) Int. Cl. G09F 13/08; F21S 8/10

(52) U.S. Cl. 362/97.1; 362/317

(57) ABSTRACT

In one embodiment, a light diffusion plate includes a base layer and a plurality of diffusion dots. The base layer includes a first surface and a second surface facing the first surface. A plurality of unit areas is defined on the first surface. The light diffusion dots are respectively formed in the unit areas, and formed having a random pattern so that the area of each of the light diffusion dots irregularly varies along arbitrary directions on the first surface.

### CROSS-REFERENCE TO RELATED APPLICATIONS

This application claims priority under 35 U.S.C. § 119 to Korean Patent Application No. 2008-116273, filed on Nov. 21, 2008 in the Korean Intellectual Property Office (KIPO), the contents of which are incorporated herein by reference in their entirety.

### BACKGROUND OF THE INVENTION

1. Field of the Invention

The present invention relates to a light diffusion plate, a method for manufacturing the light diffusion plate, and a backlight assembly having the light diffusion plate. More particularly, the present invention relates to a light diffusion plate disposed under a display panel to control light provided to the display panel, a method for manufacturing the light diffusion plate, and a backlight assembly having the light diffusion plate.

2. Description of the Related Art

Generally, a liquid crystal display (LCD) apparatus widely used as a flat panel display apparatus is a passive illumination type apparatus. Thus, the LCD apparatus includes a backlight assembly disposed on a rear surface of the display panel to provide light to the display panel.

The backlight assembly is classified as either an edge illumination type backlight assembly or a direct illumination type backlight assembly. In the edge illumination type backlight assembly, a lamp is disposed at a side of a light guide plate. In the direct illumination type backlight assembly, a plurality of lamps is disposed under the display panel. The direct illumination type backlight assembly is widely used for large display apparatuses due to high light efficiency, simple structure and suitability for wide display panels.

The direct illumination type backlight assembly includes a plurality of lamps disposed under the display panel, a reflective sheet disposed under the lamps, a diffusion plate and a diffusion sheet disposed between the lamps and the display panel to diffuse the light and to improve luminance uniformity, and a prism sheet concentrating the light to improve front luminance.

In the direct illumination type backlight assembly, bright lines occur on the display panel so that display quality may be decreased. In this case, a predetermined distance between the lamp and the display panel should be maintained to prevent the bright lines. However, the predetermined distance may increase the thickness of the LCD apparatus, and the luminance uniformity of the display panel may be decreased.

### SUMMARY OF THE INVENTION

The present invention provides a light diffusion plate preventing a profile of a light source from being visible.

The present invention also provides a method for manufacturing the light diffusion plate.

The present invention also provides a backlight assembly having the light diffusion plate so that the thickness of the backlight assembly may be decreased and the luminance uniformity of the backlight assembly may be increased.

According to one aspect of the present invention, a light diffusion plate includes a base layer and a plurality of light diffusion dots. The base layer includes a first surface where a plurality of unit areas is defined and a second surface facing the first surface. A plurality of light diffusion dots is respectively formed in each unit area. The light diffusion dots are formed having a random pattern so that the area of each of the light diffusion dots irregularly varies along arbitrary directions on the first surface.

According to another aspect of the present invention, a backlight assembly includes a light source, an optical sheet disposed over the light source and a light diffusion plate disposed between the light source and the optical sheet. The light diffusion plate includes a base layer and a plurality of light diffusion dots. The base layer includes a first surface where a plurality of unit areas is defined. A plurality of light diffusion dots is respectively formed in the unit areas. The light diffusion dots are formed having a random pattern so that the area of each of the light diffusion dots irregularly varies along arbitrary directions on the first surface.

According to still another aspect of the present invention, in a method of manufacturing a light diffusion plate, a plurality of the unit areas is defined on a first surface of a base layer. A plurality of light diffusion dots is respectively formed in the unit areas so that the area of each of the light diffusion dots irregularly varies along arbitrary directions on the first surface.

According to the present invention, the area of a light diffusion dot irregularly varies so that the profile of a light source on a front surface of an optical sheet may be prevented from being visible. Thus, a distance between the light source and a light diffusion plate may be decreased so that the thickness of a backlight assembly may be decreased. In addition, costs for manufacturing the light diffusion plate having the light diffusion dot may be decreased.

### BRIEF DESCRIPTION OF THE DRAWINGS

The above and other features and advantages of the present disclosure will become more apparent by describing embodiments thereof with reference to the accompanying drawings, in which:

FIG. 1 is a cross-sectional view illustrating a backlight assembly according to an example embodiment of the present invention;

FIG. 2 is a plan view illustrating a rear surface of a light diffusion plate;

FIG. 3 is a flowchart illustrating a method for manufacturing the light diffusion plate according to the example embodiment of the present invention;

FIG. 4 is a block diagram illustrating a random pattern generating algorithm used for the method for manufacturing the light diffusion plate in FIG. 3;

FIG. 5 is a plan view illustrating a unit area display based on unit area information outputted from a unit area generating part in FIG. 4;

FIG. 6 is a noise image display based on noise image information outputted from a noise image generating part;

FIG. 7 is a plan view illustrating a light diffusion dot formed in the unit area in FIG. 5;

FIG. 8 is a plan view illustrating the light diffusion dot printed in the unit area in FIG. 5;

FIG. 9 is a plan view illustrating the rear surface of the light diffusion plate on which the light diffusion dots are regularly distributed;

FIG. 10 is a graph showing the luminance of the light diffusion plate in FIGS. 1 to 8;

FIG. 11 is a graph showing the luminance of the light diffusion plate in FIG. 9; and

FIG. 12 is a plan view illustrating a rear surface of a light diffusion plate according to another example embodiment of the present invention.

### DETAILED DESCRIPTION OF THE INVENTION

Although the present disclosure is described more fully hereinafter with reference to the accompanying drawings, the underlying concepts may, however, be embodied in many different forms and should not be construed as limited to the embodiments set forth herein. Rather, these embodiments are provided so that this disclosure will be thorough and complete, and will fully convey its teachings to those skilled in the pertinent art. In the drawings, the sizes and relative sizes of layers and regions may be exaggerated for sake of clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the term “below” can encompass both an orientation of above and below. The apparatus may be otherwise oriented (rotated 90 degrees or at other orientations) and the spatially relative descriptors used herein interpreted accordingly.

The terminology used herein is for the purpose of describing particular embodiments and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments herein should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of an apparatus and are not intended to limit the scope of the present invention.

Unless otherwise defined, all terms (including technical and scientific terms) used herein have the same meaning as commonly understood by one of ordinary skill in the pertinent art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present disclosure of invention will be explained in detail with reference to the accompanying drawings.

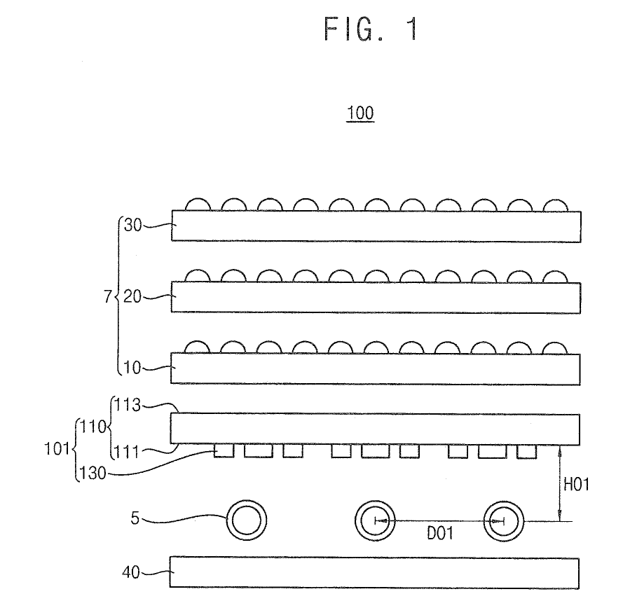

FIG. 1 is a cross-sectional view illustrating a backlight assembly according to an example embodiment of the present invention.

Referring to FIG. 1, the backlight assembly 100 according to the present example embodiment includes a light source 5, a reflective sheet 40, an optical sheet 7, and a light diffusion plate 101.

The light source 5 may include a cold cathode fluorescent lamp (CCFL) in one example. The CCFL (hereinafter referred to as a lamp) may include a straight-type lamp tube and discharging gas injected into the lamp tube. A plurality of the light sources 5 is arranged parallel with each other and are spaced apart from each other by a uniform distance.

The reflective sheet 40 is disposed under the light sources 5 and reflects light emitted from the light sources 5 back toward the light sources 5.

The optical sheet 7 is disposed over the light sources 5 and improves the luminance uniformity of the light emitted from the light sources 5. In the present example embodiment, the optical sheet 7 may include three diffusion-condensing sheets 10, 20 and 30. The diffusion-condensing sheets 10, 20 and 30 may include a base film diffusing the light and condensing lens having a lenticular shape formed on the base film. Alternatively, the optical sheet 7 may include a single diffusion sheet and two prism sheets disposed on the diffusion sheet.

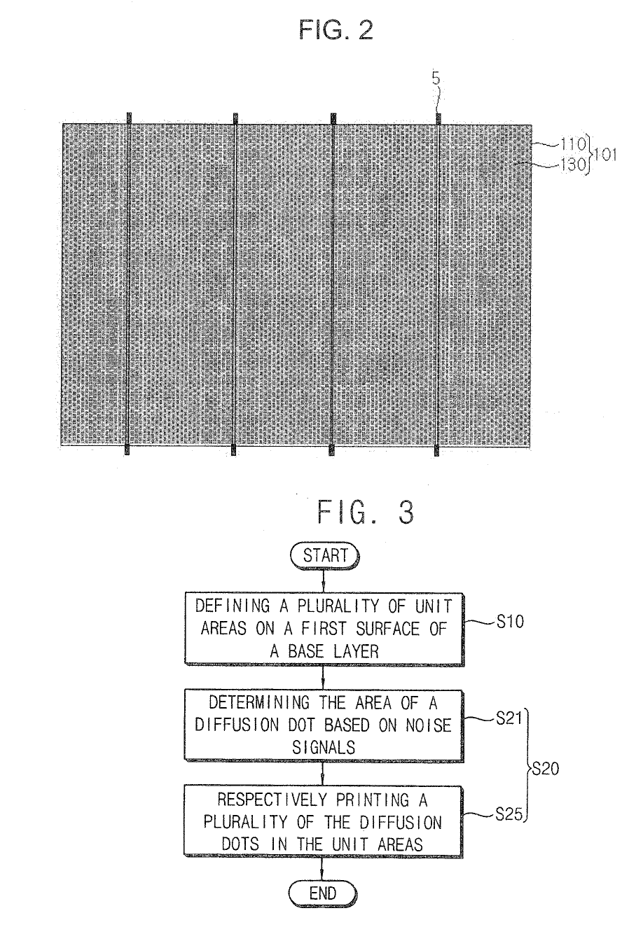

FIG. 2 is a plan view illustrating a rear surface of the light diffusion plate 101.

Referring to FIGS. 1 and 2, the light diffusion plate 101 according to the present example embodiment is disposed between the optical sheet 7 and the light sources 5. The light diffusion plate 101 is disposed close to the light sources 5. For example, when a distance between central portions of adjacent light sources 5 is defined as a lamp distance D01 and a distance between the light diffusion plate 101 and a central portion of the light sources 5 is defined as an optical distance H01, the lamp distance D01 may be three or four times larger than the optical distance H01 so that the thickness of the backlight assembly 100 may be decreased. Alternatively, the lamp distance D01 of a conventional backlight assembly may be about 1.7 times larger than the optical distance H01. Thus, the backlight assembly 100 according to the present example embodiment may provide the backlight assembly 100 having a very small thickness.

As mentioned above, although the optical distance H01 is very small, the light diffusion plate 101 effectively diffuses the light from the light sources 5 so that shapes of the light sources 5 may be prevented from being visible from a front-viewing angle. The light diffusion plate 101 includes a base layer 110 and a plurality of light diffusion dots 130.

The base layer 110 includes a first surface 111 facing the light sources 5 and a second surface 113 facing the first surface 111. A plurality of unit areas DA01 is defined on the first surface 111 as illustrated in FIG. 2. Each of the unit areas may be formed on the first surface 111 with various types, to control a dot density of the light diffusion dot 130 more easily.

The area of the light diffusion dot 130 is smaller than that of the unit area DA01. The light diffusion dots 130 partially reflect the light incident to the first surface 111, and partially transmit the incident light to the first surface 111, so that the light diffusion dots 130 diffuse the light. In the present example embodiment, the light diffusion dot 130 has a random pattern so that the area of the light diffusion dot irregularly varies along arbitrary directions on the first surface.

FIG. 3 is a flowchart illustrating a method for manufacturing the light diffusion plate according to the example embodiment of the present invention.

Referring to FIG. 3, the plurality of the unit areas DA01 is defined on the first surface 111 of the base layer 110 to manufacture the light diffusion plate 101 (step S10). The unit area DA01 may equally divide an area in which the light diffusion dot 130 is formed.

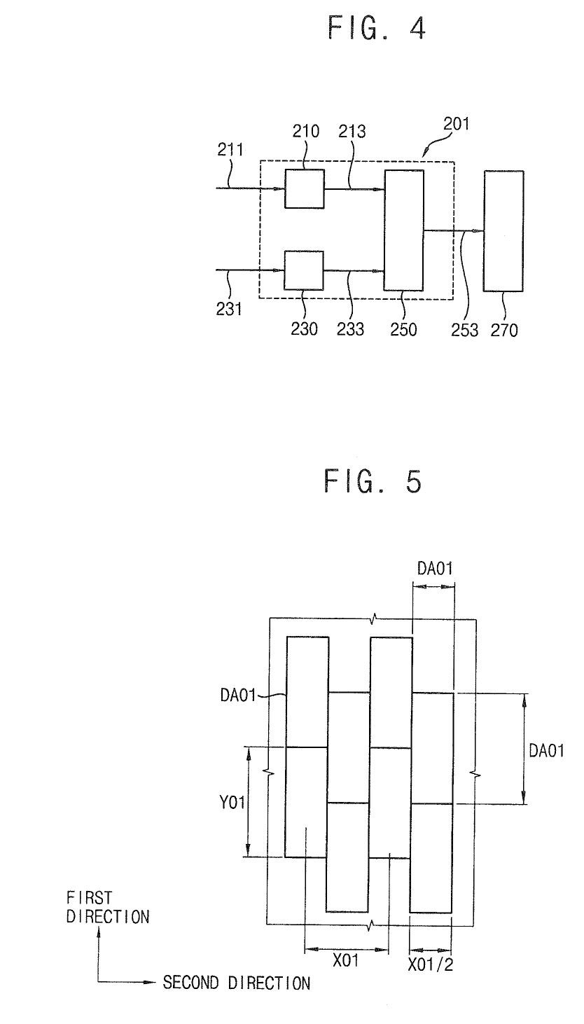

FIG. 4 is a block diagram illustrating a random pattern generating algorithm used for the method for manufacturing the light diffusion plate in FIG. 3.

Referring to FIG. 4, for example, a pattern generator 201 may be used to perform the random pattern generating algorithm. The pattern generator 201 may include a unit area generating part 210, a noise image generating part 230 and a random pattern generating part 250.

FIG. 5 is a plan view illustrating a unit area display based on unit area information outputted from a unit area generating part in FIG. 4.

Referring to FIGS. 4 and 5, the unit area generating part 210 outputs the unit area information 213 based on area division information 211 inputted from the exterior. The area division information 211 may include information on the unit area DA01 such as a shape, arrangement form, a side size along a first direction Y01 and a side size along a second direction X01/2. In this case, the first and second directions may be perpendicular to each other. The shape, the arrangement form and the side sizes are not limited to the present example embodiment in FIG. 5. The unit area information 213 may be displayed as an image illustrated in FIG. 5.

In the present example embodiment, each of the unit areas DA01 has a uniform size and is formed to make contact with each other. The unit area DA01 has a rectangular shape. The unit areas DA01 are arranged in a line along a first direction, so that the entire side of the unit area DA01 along the second direction may make contact with the entire side of an adjacent unit area DA01 along the second direction. The unit areas DA01 disposed adjacent to each other along the first direction are shifted along the first direction with respect to each other. Thus, the unit areas DA01 disposed adjacent to each other may make partial contact with each other along the first direction. For example, the side of the unit area DA01 may make half contact with the side of an adjacent unit area DA01.

Then, the light diffusion dots 130 are respectively formed in the unit areas DA01, so that the area of each of the light diffusion dots 130 irregularly varies along arbitrary directions on the first surface 111 (step S20).

To form the light diffusion dot 130, the area of the light diffusion dot 130 is firstly determined using the random pattern generating algorithm so that the area of the light diffusion dot follows luminance distribution of a noise image (step S21).

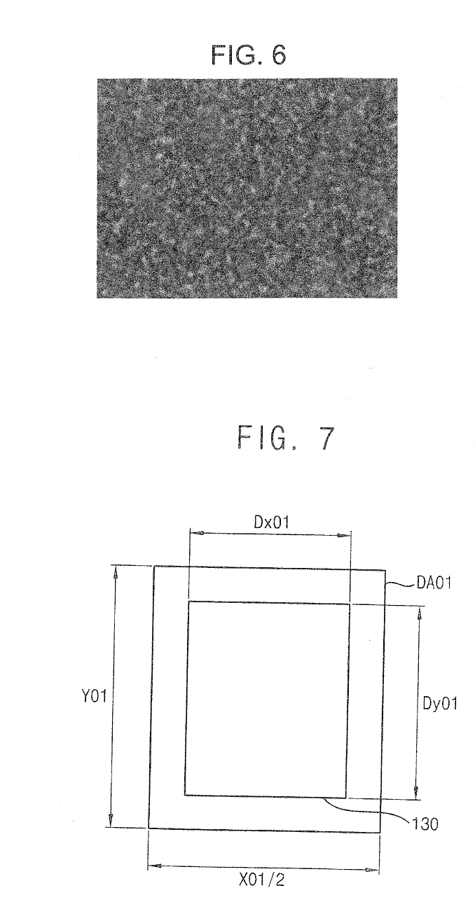

FIG. 6 is a noise image display based on noise image information outputted from a noise image generating part.

Referring to FIGS. 4 and 6, the noise image generating part 230 outputs the noise image information 233 based on noise signals 231. The noise image generating part 230 may include a noise filter such as a paint shop. The noise signals 231 applied to the noise filter may include various types. For example, the noise signals 231 may include noise patterns selected among various types of noise patterns and processing information. The processing information may include data processing parameters compensating the noise patterns. For example, the processing information may include information on upper and lower limits related to luminance differences between adjacent pixels in the image having the selected noise patterns, and on increases and decreases in size of each pixel, etc.

The noise image generating part 230 generates the noise image information 233 through compensating the noise patterns based on the processing information. The noise image information 233 may include the compensated luminance of the pixels of the noise patterns. The noise image display based on the noise image information 233 may be a bitmap image as illustrated in FIG. 6.

The random pattern generating part 250 may determine the area of the light diffusion dot 130 formed in the unit areas DA01, based on the unit area information 213, the noise image information 233 and the transmittance of the light diffusion dot 130. For example, the random pattern generating part 250 may determine the average luminance of the unit areas DA01 based on the luminance of the pixels included in the unit area DA01 of the noise information. In this case, the luminance of pixels may be provided from the information on the luminance information of the pixels included in the noise image information 233. Thus, the random pattern generating part 250 may determine the area of the light diffusion dot 130 based on the average luminance of the unit area DA01, the transmittance of the light diffusion dot 130 and the average luminance of the light from the light sources 5. The area of the light diffusion dot 130 may be calculated by the random pattern generating part as follows.

FIG. 7 is a plan view illustrating a light diffusion dot formed in the unit area in FIG. 5.

Referring to FIG. 7, the area of the light diffusion dot 130 is smaller than that of the unit area DA01, and the light diffusion dot 130 is spaced apart from the sides of the unit area along the first and second directions.

An equilibrium {total amount of light emitted from the unit area DA01=amount of light from the area having no light diffusion dots 130+amount of light from the light diffusion dot 130} may be satisfied based on geometrical shapes of the unit area DA01 and the light diffusion dot 130.

The total amount of light from the unit area DA01, I_{avg}(lumen; lm), may be expressed as Equation 1.

I_{avg}=∫i_{avg}dA=i_{avg}∫dA=i_{avg}A [Equation 1]

I_{avg}: average quantity of light per unit area (lm/m²)

A=(Y01)(X01/2): area of unit area DA01

The amount of light from the area having no light diffusion dot 130 of the unit area DA01, (1−ρ) Iₗₐₘₚ, may be expressed as Equation 2.

$$\begin{matrix}( 1 - ρ ) {I}_{lamp} = \int ( 1 - ρ ) i d A \\ = ( 1 - ρ ) \int i d A \\ = ( 1 - ρ ) \int \int i ( X ) d x d y \\ = ( 1 - ρ ) Y 01 {\int }_{- X 01 / 4}^{X 01 / 4} i ( X ) d x\end{matrix} \qquad [ Equation 2 ]$$

ρ=A_{d}/A: dot density defined as ratio of area of light diffusion dot 130 with respect to unit area DA01

Iₗₐₘₚ: average luminance of light source 5

A_{d}: area of light diffusion dot 130

i(X): quantity of light per unit area (lm/m²) from differential area dA, wherein i(X) is a function only related to X.

The amount of light from the light diffusion dot 130 of the unit area DA01, ρTIₗₐₘₚ, may be expressed as Equation 3.

$$\begin{matrix}ρ {TI}_{lamp} = \int ρ T i ( X ) d A \\ = ρ T \int i ( X ) d A \\ = ρ T \int \int i ( X ) d x d y \\ = ρ TY 01 {\int }_{- X 01 / 4}^{X 01 / 4} i ( X ) d x\end{matrix} \qquad [ Equation 3 ]$$

T: transmittance of light diffusion dot 130, T<1.0

Equation 1 may be simply expressed as Equation 4 from Equation 2 and Equation 3.

I_{avg}=(1−ρ)Iₗₐₘₚ+ρTIₗₐₘₚ [Equation 4]

As mentioned above, the random pattern generating part 250 may determine the average luminance of the unit area DA01, I_{avg}, based on the luminance of the pixels included in the unit area DA01. In this case, the noise image information 233 may include the information on the luminance of the pixels. The average luminance of the light source 5, Iₗₐₘₚ, may be easily measured using a luminance measurement apparatus. When the average luminance of the unit area DA01 calculated by the random pattern generating part 250 is equal to the average luminance of the light source 5, Iₗₐₘₚ, the dot density of the light diffusion dot 130 may be calculated. Thus, the area of the light diffusion dot 130, A_{d}, may be calculated using the equation ρ=A_{d}/A.

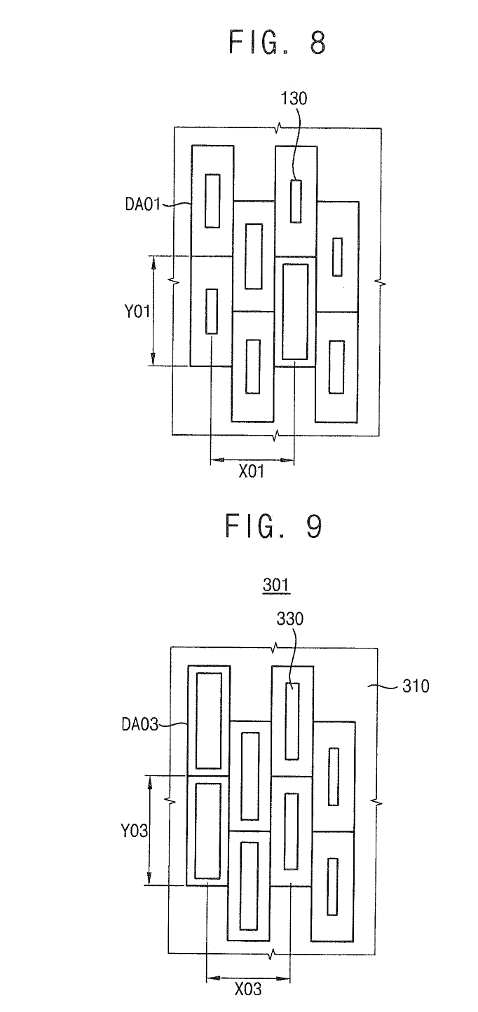

FIG. 8 is a plan view illustrating the light diffusion dot printed in the unit area in FIG. 5.

Then, the light diffusion dots 130 are printed in the unit areas DA01 so that each of the light diffusion dots 130 has the above-mentioned predetermined area (step S25).

For example, the light diffusion dots 130 may be formed using a silkscreen printing process. In the silkscreen printing process, a silkscreen printing apparatus 270 may print the light diffusion dots 130 on the first surface 111 of the base layer 110 based on printing information 253 provided from the pattern generator 201 in FIG. 4, so that the light diffusion plate 101 may be manufactured. The printing information 253 may include information on the area of the light diffusion dot 130 and randomized patterns.

For example, the light diffusion dots 130 may be formed using an ink including a filler having the light transmittance in a range between about 40% to about 80%. The ink may be formed using a white ink and a transparent ink. For example, the filler may include titanium dioxide (TiO₂). For example, considering dispersibility of the ink, TiO₂ may be in the range between about 13 wt % and about 17 wt %, and more specifically TiO₂ may be about 13 wt % in the blend of the ink and the filler.

When the amount of TiO₂ in the ink is increased, the blocking function and reflectivity of the light diffusion plate 101 may be increased. However, when the ink includes too much filler, a chromaticity diagram of the light passing through the light diffusion plate 101 in the area where the dot density of the light diffusion dot 130 is higher than that in other areas may become yellowish. In this case, a blue colorant may be included in the blend in the range between about 0.2 wt % to about 0.4 wt % for preventing the yellowing, and more specifically the blue colorant may be included in the blend at about 0.3 wt %.

A protective layer may be further formed on the first surface 111 to cover and protect the light diffusion dots 130. In addition, a condensing lens may be further formed on the second surface 113 of the base layer 110. For example, the condensing lens may be a lenticular-type lens. A light diffuser which may have a particle shape may be distributed in the base layer 110, and scatters incident light, so that the light diffusion plate 101 may diffuse light more effectively.

In FIG. 8, the dot density is determined according to the noise image. Thus, the area of the light diffusion dot 130 irregularly varies along arbitrary directions. Thus, the shape of the lamps may be hardly visible through the optical sheet 7 due to the random pattern of the light diffusion dots 130. For example, irregular and aperiodic patterns of the light diffusion dots 130 may have profiles of the light sources 5 that are dispersed, so that the profiles of the light sources 5 may be hardly visible.

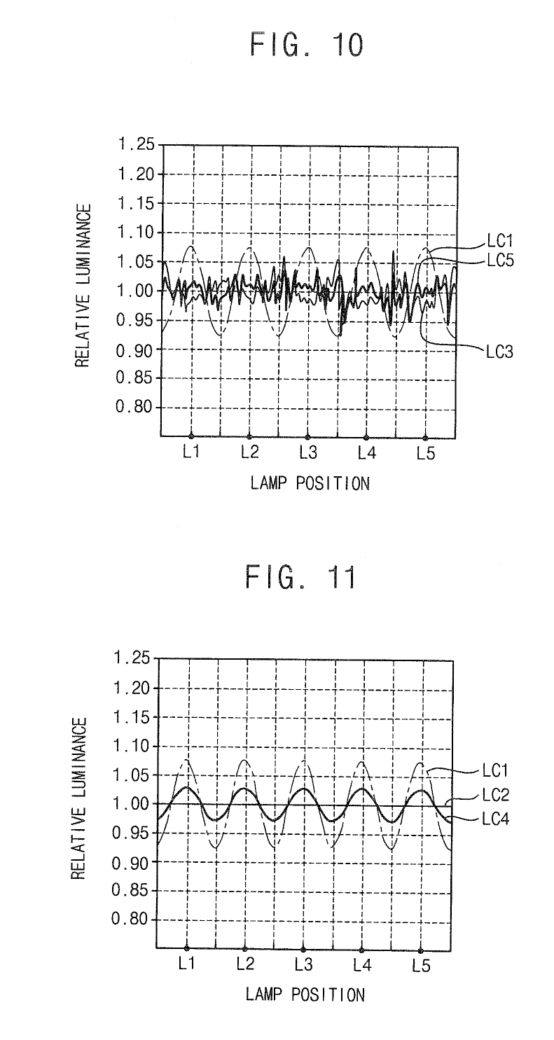

FIG. 9 is a plan view illustrating the rear surface of the light diffusion plate on which the light diffusion dots are regularly distributed.

Referring to FIG. 9, the regular light diffusion plate 301 is formed to compare the regular light diffusion plate 301 to the light diffusion plate 101 according to the present example embodiment. For example, the regular light diffusion plate 301 may have a periodic pattern. The areas of the light diffusion dots 330 of the regular diffusion plate 301 are uniform along the first direction, and periodically vary along the second direction. For example, the areas of the light diffusion dots 330 of the regular diffusion plate 301 increases when a dot position is close to a position corresponding to the light sources 5, and decreases when the dot position is close to a middle point between the light sources 5.

FIG. 10 is a graph showing the luminance of the light diffusion plate in FIGS. 1 to 8. FIG. 11 is a graph showing the luminance of the light diffusion plate in FIG. 9.

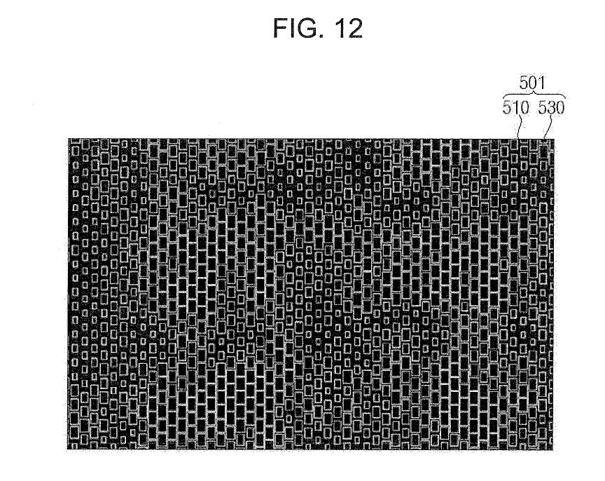

Referring to FIGS. 10 and 11, a horizontal axis indicates positions where the light sources 5 are disposed. The light sources 5 are arranged parallel with each other, and spaced apart from each other by a uniform distance. The light sources 5 are disposed on L1, L2, L3, L4 and L5 in FIGS. 11 and 12. A vertical axis in FIG. 10 indicates the luminance observed in front of the optical sheet 7 of the backlight assembly 100. The vertical axis in FIG. 11 indicates the luminance observed in front of the optical sheet 7 of the backlight assembly 100 having the regular light diffusion plate 301 in FIG. 9.

In FIGS. 10 and 11, when the average luminance in front of the optical sheet is indicated as 1.00, the luminance observed in front of the optical sheet 7 varies according to the position related to the light sources 5.

In FIGS. 10 and 11, a first luminance curve LC1 shows luminance distribution when the light sources 5 is directly observed without the light diffusion plate 101, the regular light diffusion plate 301 and the optical sheet 7. Referring to the first luminance curve LC1, luminance differences between points directly above the light sources 5 and middle points between the light sources 5 are very large, and the first luminance curve LC1 follows a sine shape or a cosine shape.

In FIGS. 10 and 11, a second luminance curve LC2 and a third luminance curve LC3 show the luminance distribution in front of the optical sheet 7 when the backlight assembly 100 is under ideal conditions without external disturbances. The external disturbances may include distortion of the light diffusion plate 101 and the regular light diffusion plate 301, deviation in the reflection and transmittance of the light diffusion dots 130 and 330 due to excess ink, deformation of the reflective sheet 40 and high-sensitive eyes of user for periodic light and shade.

Referring to the second luminance curve LC2 in FIG. 11, under ideal conditions, the luminance distribution of the regular light diffusion plate 301 may be uniform due to the periodic dot pattern. However, referring to the third luminance curve LC3 in FIG. 10, under ideal conditions, the luminance distribution of the light diffusion plate 101 according to the present example embodiment is very irregular due to the random pattern of the light diffusion dots 130, but the range of fluctuation of the third luminance curve LC3 is small and wave patterns are very minute. Thus, the profiles of the light sources 5 may be dispersed, so that the profiles of the light sources 5 may be hardly visible.

However, to remove or prevent the external disturbances is nearly impossible. Thus, the luminance distribution with the external disturbances may be probable. In FIGS. 10 and 11, a fourth luminance curve LC4 and a fifth luminance curve LC5 show the luminance distribution in the front of the optical sheet 7 when the backlight assembly 100 is under actual conditions with the external disturbances.

Referring to the fourth luminance curve LC4 in FIG. 11, under actual conditions, the luminance distribution of the regular light diffusion plate 301 may be irregular but fluctuate according to the periodic pattern related to the light sources 5 positions. Thus, the profiles of the light sources 5 in front of the optical sheet 7 may be easily visible due to the periodic luminance distribution. Thus, in a liquid crystal display (LCD) apparatus including the regular light diffusion plate 301, bright lines on a liquid crystal display panel may be visible, so that display quality of the LCD apparatus may be decreased.

However, referring to the third luminance curve LC5 in FIG. 10, under actual conditions, the luminance distribution of the light diffusion plate 101 according to the present example embodiment is very irregular due to the random pattern of the light diffusion dots 130, but the range of fluctuation of the third luminance curve LC3 is small and wave patterns are very minute. Thus, the profiles of the light sources 5 may be dispersed, so that the profiles of the light sources 5 may be hardly visible.

Thus, in accordance with this embodiment, the luminance uniformity of the backlight assembly 100 may be increased. Also, the light diffusion plate 101 may be manufactured by using conventional silk printing methods excluding the random pattern of the light diffusion dots 130. Thus, additional costs may not be required for the light diffusion plate 101 in this embodiment.

FIG. 12 is a plan view illustrating a rear surface of a light diffusion plate according to another example embodiment of the present invention.

Referring to FIG. 12, the light diffusion plate 501 may be applied to a backlight assembly including a point light source such as a light-emitting diode (LED). Light diffusion dots 530 having a random pattern are formed on a first surface of a base layer 510 of the light diffusion plate 501 as illustrated in FIG. 12, so that the areas of the light diffusion dots 530 may irregularly vary along arbitrary directions on the first surface. An algorithm such as the pattern generator may be used to form the random pattern. Noise pattern information used in the present example embodiment may be different from the noise pattern information used in the previous example embodiment in FIGS. 1 to 8. For example, a noise pattern may be selected by trial and error, considering a light source type and a light source arrangement.

A method for manufacturing the light diffusion plate according to the present example embodiment is substantially the same as the method for manufacturing the light diffusion plate according to the previous example embodiment described above with reference to FIGS. 3 to 8, except for changing the noise pattern. Thus, further descriptions of the method for manufacturing the light diffusion plate according to the present example embodiment will be omitted.

A backlight assembly according to the present example embodiment is substantially the same as the backlight assembly according to the previous example embodiment described with reference to FIGS. 1 to 8, except for including the light diffusion plate 501 illustrated in FIG. 12. Thus, further descriptions of the backlight assembly according to the present example embodiment will be omitted.

According to example embodiments of the present invention, the profiles of a light source such as a lamp may be hardly visible in front of a sheet disposed on a light diffusion plate, so that the distance between the light source and the light diffusion plate may be decreased. Thus, the thickness of a backlight assembly may be decreased, and costs for manufacturing the light diffusion plate may be decreased. Thus, the example embodiments of the present invention may be used in improving luminance uniformity and decreasing the thickness of the backlight assembly.

The foregoing is illustrative and is not to be construed as limiting of the teachings provided herein. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present teachings. In the below claims, means-plus-function clauses are intended to cover the structures described herein as performing the recited function and not only structural equivalents but also functionally equivalent structures. Therefore, it is to be understood that the foregoing is illustrative and is not to be construed as limited to the specific example embodiments disclosed, and that modifications to the disclosed example embodiments, as well as other example embodiments, are intended to be included within the scope of the teachings.

What is claimed is:

1. A light diffusion plate, comprising:
a base layer including a first surface where a plurality of unit areas is defined and a second surface facing the first surface; and
a plurality of light diffusion dots formed on the first surface, each light diffusion dot formed in a respective unit area of the plurality of unit areas, wherein an area of each of the light diffusion dots irregularly varies along arbitrary directions on the first surface.

2. The light diffusion plate of claim 1, wherein the light diffusion dots are distributed based on information on shapes of the unit areas and noise signals.

3. The light diffusion plate of claim 2, wherein each of the light diffusion dots has an area calculated by I_{avg}=(1−ρ)Iₗₐₘₚ+ρTIₗₐₘₚ, wherein ρ is a dot density defined as a ratio of the area of each of the light diffusion dots with respect to each of the unit areas, Iₗₐₘₚ is an average luminance of a light source emitting light to the first surface, I_{avg} is an average luminance of light passing through each of the unit areas, and T is a light transmittance of each of the light diffusion dots.

4. The light diffusion plate of claim 3, wherein each of the unit areas has a rectangular shape and is arranged in a line along a first direction so that entire sides of the unit areas along a second direction substantially perpendicular to the first direction make contact with each other, and the unit areas adjacent to each other are shifted along the first direction with respect to each other so that the sides of the unit areas along the first direction make partial contact with each other.

5. The light diffusion plate of claim 4, wherein the area of each of the light diffusion dots is smaller than that of each of the unit areas, and each of the light diffusion dots is spaced apart from the sides of each of the unit areas along the first and second directions.

6. The light diffusion plate of claim 2, wherein the light diffusion dots have the light transmittance in a range between about 40% to about 80%.

7. The light diffusion plate of claim 2, further comprising:
a condensing lens formed on the second surface; and
a light diffuser distributed in the light diffusion plate.

8. A backlight assembly comprising:
a light source;
an optical sheet disposed over the light source; and
a light diffusion plate disposed between the light source and the optical sheet, the light diffusion plate including:
a base layer having a first surface where a plurality of unit areas is defined; and
a plurality of light diffusion dots formed on the first surface, each light diffusion dot formed in a respective unit area of the plurality of unit areas, wherein an area of each of the light diffusion dots irregularly varies along arbitrary directions on the first surface.

9. The backlight assembly of claim 8, wherein the light diffusion dots are distributed based on information on shapes of the unit areas and noise signals.

10. The backlight assembly of claim 9, wherein the light source includes a plurality of lamps arranged parallel with each other, and a distance between central portions of adjacent lamps is three or four times larger than the distance between a central portion of the lamp and the light diffusion plate.

11. The backlight assembly of claim 10, wherein the optical sheet includes two or three light diffusion sheets.

12. The backlight assembly of claim 9, wherein the light source includes a light-emitting diode (LED).

13. The backlight assembly of claim 9, wherein each of the light diffusion dots has an area calculated by I_{avg}=(1−ρ)Iₗₐₘₚ+ρTIₗₐₘₚ, wherein ρ is a dot density defined as a ratio of the area of each of the light diffusion dots with respect to each of the unit areas, Iₗₐₘₚ is an average luminance of a light source emitting light to the first surface, I_{avg} is an average luminance of the light passing through each of the unit areas, and T is a light transmittance of each of the light diffusion dots.

14. The backlight assembly of claim 13, wherein each of the unit areas has a rectangular shape and is arranged in a line along a first direction so that entire sides of the unit areas along a second direction substantially perpendicular to the first direction make contact with each other, and the unit areas adjacent to each other are shifted along the first direction with respect to each other so that the sides of the unit areas along the first direction make partial contact with each other.

15. A method of manufacturing a light diffusion plate, the method comprising:
defining a plurality of unit areas on a first surface of a base layer; and
forming a plurality of light diffusion dots on the first surface, each light diffusion dot formed in a respective unit area of the plurality of the unit areas, wherein an area of each of the light diffusion dots irregularly varies along arbitrary directions on the first surface.

16. The method of claim 15, wherein each of the light diffusion dots is formed by:
determining the area of each of the light diffusion dots using a random pattern generating algorithm having input information on shapes of the unit areas and noise signals; and
respectively printing the light diffusion dots in the unit areas so that each of the light diffusion dots has a predetermined area.

17. The method of claim 16, wherein determining the area of the light diffusion dot is determined by:
generating unit area information using the random pattern generating algorithm based on an input having area division information, the area division information having the information on the shapes of the unit areas;
generating noise image information using the random pattern generating algorithm based on the noise signals; and
determining the area of each of the light diffusion dots using the random pattern generating algorithm based on the input having the unit area information, the noise image information and light transmittance of each of the light diffusion dots.

18. The method of claim 17, wherein each of the light diffusion dots has the area calculated by I_{avg}=(1−ρ)Iₗₐₘₚ+ρTIₗₐₘₚ, wherein ρ is a dot density defined as a ratio of the area of each of the light diffusion dots with respect to each of the unit areas, Iₗₐₘₚ is an average luminance of a light source emitting light to the first surface, I_{avg} is an average luminance of the light passing through each of the unit areas, and T is a light transmittance of each of the light diffusion dots.

19. The method of claim 17, wherein each of the light diffusion dots is formed by using an ink blend including a filler having the light transmittance in a range between about 40% to about 80%.

20. The method of claim 19, wherein the filler includes titanium dioxide (TiO₂), and the ink blend includes TiO₂ between about 13 wt % to about 17 wt % and blue colorant between about 0.2 wt % to about 0.4 wt %.
